(19) United States
(12) Patent Application Publication
(10) Pub. No.: US 2019/0293982 A1
(43) Pub. Date: Sep. 26, 2019

(54) System and Method for Altering the Polarization of Light Emitted by a Liquid Crystal Display

(71) Applicant: Alloy Compass 1, LLC, Washington Crossing, PA (US)

(72) Inventor: Quinn Schwenker, Washington Crossing, PA (US)

(73) Assignee: Alloy Compass 1, LLC

(21) Appl. No.: 16/360,224

(22) Filed: Mar. 21, 2019

Related U.S. Application Data
(60) Provisional application No. 62/646,240, filed on Mar. 21, 2018.

(51) Int. Cl. G02F 1/13363; G02F 1/1333; G02F 1/1335

(52) U.S. Cl. CPC G02F 1/13363; G02F 1/133308; G02F 1/133502; G02F 2413/05; G02F 2001/133331; G02F 2001/133562; G02F 2413/01; G02F 2001/133638

(57) ABSTRACT

A liquid crystal display with an overlay assembly. The liquid crystal display emits linearly polarized light. A quarter-wave plate is provided that covers the liquid crystal display. The linearly polarized light of the liquid crystal display is converted into circularly polarized light by the quarter-wave plate. The quarter-wave plate has a fast axis and a slow axis, wherein the linearly polarized light passing through the fast axis travels more quickly than through the slow axis, therein converting the linearly polarized light into circularly polarized light. A cover plate is provided that covers and protects the quarter-wave plate.

### RELATED APPLICATIONS

This application claims the benefit of U.S. Provisional Patent Application Ser. No. 62/646,240, filed Mar. 21, 2018.

### BACKGROUND OF THE INVENTION

### 1. Field of the Invention

In general, the present invention relates to the systems that are designed to alter the polarization of light emitted by a display. More particularly, the present invention relates to systems that alter the polarization of light emitted by a liquid crystal display so that the display can be more accurately viewed by a person wearing polarized sunglasses.

### 2. Prior Art Description

It is well known that the image created by a liquid crystal display (LCD) is optically polarized. Each pixel of an LCD typically consists of a layer of liquid crystal molecules that are aligned between two transparent electrodes and two polarizing filters. The polarizing filters are arranged at right angles on the primary the axes of transmission.

Most modern LCD displays are twisted nematic devices. In a twisted nematic device, the surface alignment of two transparent electrodes are set perpendicular to each other. As such, the liquid crystal molecules arrange themselves in a helical structure, or twist. This induces the rotation of the polarization of the incident light. If a large enough voltage is applied to the transparent electrodes, the liquid crystal molecules are almost completely untwisted by the resulting magnetic field. Accordingly, the polarization of the incident light is not rotated. This polarized light will then be blocked by the second filter creating a black section on the display.

LCDs are used on many products. Among many things, LEDs are used as data displays in vehicles and on boats. As such, it is not unusual for an LCD to be viewed by a person wearing a set of polarized sunglasses. Since the image on an LCD is linearly polarized, viewing that display with polarized sunglasses can create cancellation zones. That is, sections of the LCD can be blocked by the polarized sunglasses and the image presented by the LCD may be partially or completely blocked from view. This is especially dangerous if the cancelled light alters part of the image and creates a false display. For example, depending upon the angle of view, a person wearing polarized sunglasses may view an “8” on an LCD as a “4” or a “6”.

A need therefore exists for a system that can modify an LCD, so its output can be accurately viewed by a person wearing polarized sunglasses. This need is met by the present invention.

### SUMMARY OF THE INVENTION

The present invention is a liquid crystal display with an overlay assembly. The liquid crystal display emits linearly polarized light. A quarter-wave plate is provided that covers the liquid crystal display. The linearly polarized light of the liquid crystal display is converted into circularly polarized light by the quarter-wave plate. The quarter-wave plate has a fast axis and a slow axis, wherein the linearly polarized light passing through the fast axis travels more quickly than through the slow axis, therein converting the linearly polarized light into circularly polarized light.

A cover plate is provided that covers and protects the quarter-wave plate. The cover plate can be made of birefringent material and can be covered in an anti-glare film.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is an exploded perspective view showing the present invention system in conjunction with a conventional liquid crystal display; and

FIG. 2 shows a cross-sectional schematic of the system presented in FIG. 1.

### DETAILED DESCRIPTION OF THE DRAWINGS

Although the present invention system can be adapted for use in many types of liquid crystal displays (LCDs), only one exemplary embodiment is presented for the purposes of explanation and discussion. The exemplary embodiment is selected in order to set forth one of the best modes contemplated for the invention. The illustrated embodiment, however, is merely exemplary and should not be considered a limitation when interpreting the scope of the appended claims.

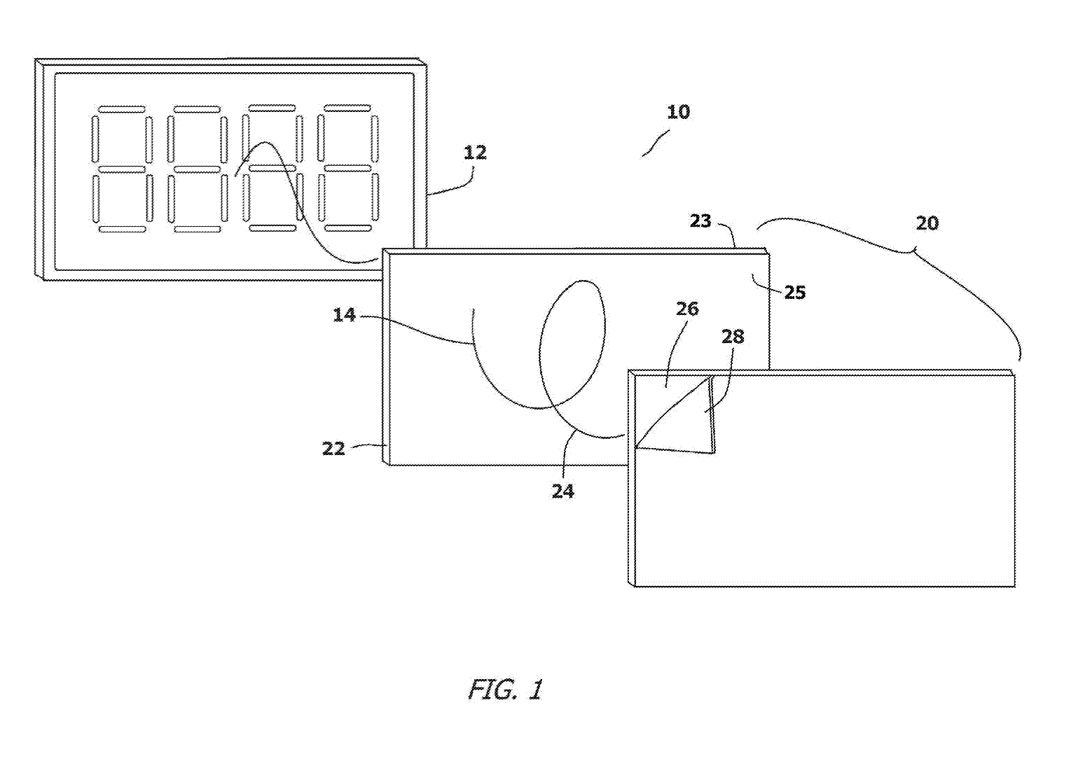

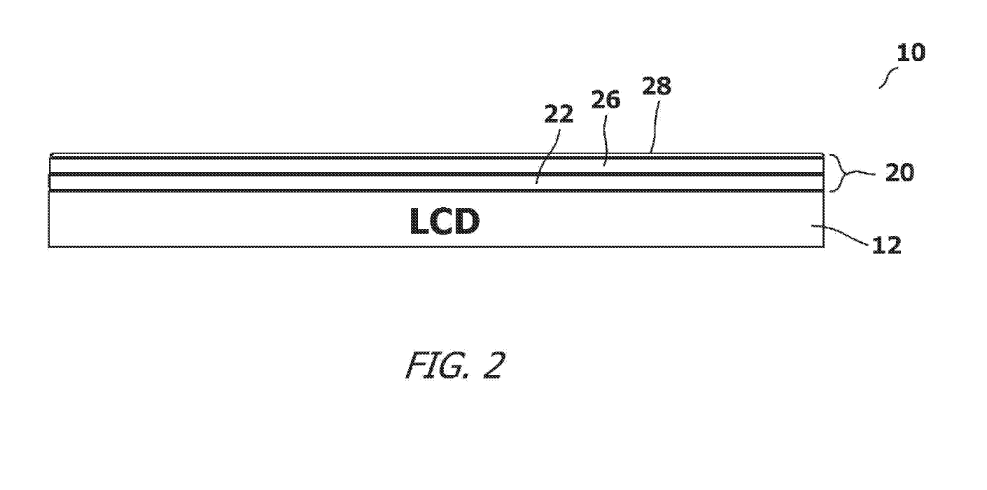

Referring to FIG. 1 in conjunction with FIG. 2, a system 10 is presented for altering the polarization of light being emitted from an LCD 12. A commercially available LCD 12 is provided. The LCD 12 produces linearly polarized light 14, as is inherent in its design. This linearly polarized light 14 cannot be reliably viewed by a person wearing polarized sunglasses.

An overlay assembly 20 is provided. The overlay assembly 20 can be built into the structure of the LCD 12 or the overlay assembly 20 can be an after-market add-on for a commercial LCD. The overlay assembly 20 includes a quarter-wave plate 22. The quarter-wave plate 22 can be a rigid plate or an engineered flexible plastic film. The quarter-wave plate 22 converts the linearly polarized light 14 of the LCD 12 into circularly polarized light 24. The quarter-wave plate 22 is made of birefringent materials that retards the polarization state differently along different axes. The quarter-wave plate 22 has a fast (extraordinary) axis and a slow (ordinary) axis. As the linearly polarized light 14 passes through the quarter-wave plate 22, the polarized light 14 passing through the fast axis travels more quickly than through the slow axis. The quarter-wave plate 22 retards the velocity of the polarized light 14 in the slow axis by one quarter of a wavelength so that it moves out of phase from the other polarization component. The polarized light 14 passing through the quarter-wave plate 22 thus becomes circularly polarized.

Since the light is circularly polarized, the light is not effectively blocked by polarized sunglasses. The LCD 12 display can therefore be accurately viewed by a person wearing polarized sunglasses.

The quarter-wave plate 22 has a first surface 23 that faces the LCD 12 and a second surface 25 that faces away from the LCD 12. The second surface 25 is protected by a clear cover plate 26. The cover plate 26, itself, can be made from birefringent material to further ensure that the light passing through the quarter-wave plate 22 is not linearly polarized. To further ensure the visibility of the overall display, the clear cover plate 26, itself can have a non-glare coating. Alternatively, a non-glare film 28 can be applied to the cover plate 26 to complete the overlay assembly 20.

It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. An overlay assembly for a liquid crystal display that emits linearly polarized light, said assembly comprising:
a quarter-wave plate sized to cover said liquid crystal display, wherein said linearly polarized light is converted into circularly polarized light by said quarter-wave plate, and wherein said quarter-wave plate has a first surface that faces said liquid crystal display and a second surface that faces away from said liquid crystal display; and
a cover plate that covers said second surface of said quarter-wave plate.

2. The assembly according to claim 1, wherein said cover plate is made from birefringent material.

3. The assembly according to claim 1, further including a non-glare film covering said cover plate.

4. The assembly according to claim 1, wherein said quarter-wave plate has a fast axis and a slow axis, wherein said linearly polarized light passing through said fast axis travels more quickly than through said slow axis, therein producing said circularly polarized light.

5. A display assembly, comprising:
an LCD display that emits linearly polarized light;
a quarter-wave plate covering said LCD display, wherein said linearly polarized light is converted into circularly polarized light by said quarter-wave plate, and wherein said quarter-wave plate has a first surface that faces said LCD display and a second surface that faces away from said LCD display; and
a cover plate that covers said second surface of said quarter-wave plate.

6. The assembly according to claim 5, wherein said cover plate is made from birefringent material.

7. The assembly according to claim 5, further including a non-glare film covering said cover plate.

8. The assembly according to claim 5, wherein said quarter-wave plate has a fast axis and a slow axis, wherein said linearly polarized light passing through said fast axis travels more quickly than through said slow axis, therein producing said circularly polarized light.
